(19) United States
(12) Patent Application Publication
(10) Pub. No.: US 2009/0023076 A1
(43) Pub. Date: Jan. 22, 2009

(54) POLYMER ELECTROLYTE AND BATTERY USING SAME

(75) Inventors: Yukifumi Takeda, Fukushima (JP); Yoshiaki Naruse, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/908,380

(22) PCT Filed: Mar. 8, 2006
(86) PCT No.: PCT/JP2006/304446

§ 371 Date: Sep. 11, 2007

(30) Foreign Application Priority Data
Mar. 14, 2005 (JP) 2005-071627

(51) Int. Cl. H01M 6/16

(52) U.S. Cl. 429/332

(57) ABSTRACT

A polymer electrolyte with the superior chemical stability and the high ion conductivity and a battery using it are provided. A polymer electrolyte (23) contains a polymer compound having a structure in which polyvinyl acetal is polymerized and an electrolytic solution containing a solvent and an electrolyte salt. The solvent contains 80 wt % or more of carbonate ester in which a cyclic compound such as ethylene carbonate and a chain compound such as methyl ethyl carbonate are mixed. The weight ratio between the cyclic compound and the chain compound in carbonate ester is in the range from 2:8 to 5:5. Thereby, high ion conductivity can be obtained. In addition, even when the ratio of carbonate ester in the solvent is increased, the solubility of polyvinyl acetal can be improved.

### TECHNICAL FIELD

The present invention relates to a polymer electrolyte containing an electrolytic solution and a polymer compound and a battery using the same.

### BACKGROUND ART

In recent years, many portable electronic devices such as combination cameras (videotape recorder), mobile phones, and portable computers have been introduced, and their size and weight have been reduced. Accordingly, as a portable power source for the electronic devices, batteries, in particular secondary batteries have been actively developed. Specially, lithium ion secondary batteries have attracted attention as a battery capable of realizing a high energy density. For the battery that is thin, is flexible, and has a shape with the high degree of freedom, many researches have been made.

For such a battery having the shape with the high degree of freedom, a polymer electrolyte in a whole solid state in which an electrolyte salt is dissolved in a polymer compound, a gelatinous polymer electrolyte in which an electrolytic solution is held in a polymer compound or the like is used. Specially, since the gelatinous polymer electrolyte holds the electrolytic solution, the contact characteristics with an active material and the ion conductivity are superior compared to the polymer electrolyte in the whole solid state. Further, the gelatinous polymer electrolyte has characteristics that liquid leakage less likely occurs compared to in the electrolytic solution. Therefore, the gelatinous polymer electrolyte has attracted attention.

For a macromolecule used for the gelatinous polymer electrolyte, researches have been made for various materials from an ether macromolecule to methyl methacrylate, polyvinylidene fluoride and the like. Of those researched, there are macromolecules using polyvinyl acetal such as polyvinyl formal and polyvinyl butyral.

For example, in Patent documents 1 and 2, an ion-conductive solid composition of matter using polyvinyl butyral is described. In Patent document 3, a gelatinous electrolyte containing polyvinyl formal and an electrolytic solution is described. Further, in Patent document 4, a gelatinous electrolyte in which the amount of the electrolytic solution is increased by adjusting the amount of the hydroxyl group contained in polyvinyl formal is described. Furthermore, in Patent document 5, the gelatinous electrolyte formed by using an epoxy cross-linking agent and a catalyst is described.

Patent document 1: Japanese Unexamined Patent Application Publication No. 57-143355
Patent document 2: Japanese Unexamined Patent Application Publication No. 57-143356
Patent document 3: Japanese Unexamined Patent Application Publication No. 03-43909
Patent document 4: Japanese Unexamined Patent Application Publication No. 2001-200126
Patent document 5: U.S. Pat. No. 3,985,574

### DISCLOSURE OF THE INVENTION

However, there has been a problem that the solubility of polyvinyl acetal to the solvent is low. Therefore, in the past, it has been considered to improve the solubility of polyvinyl acetal by, for example, mixing ethylene carbonate and alcohol such as methanol or by mixing ethylene carbonate and ether such as tetrahydrofuran. However, though the solubility of polyvinyl acetal is improved when alcohol is used, reactivity with an alkali metal such as lithium (Li) as an electrode reactant becomes high, and the capacity and the cycle characteristics are lowered. Further, when ether is used, the oxidation resistance is lowered, and decomposition reaction occurs in the cathode.

In view of the foregoing, it is an object of the invention to provide a polymer electrolyte with the superior chemical stability and the high ion conductivity, and a battery using the same.

A polymer electrolyte according to the invention contains a polymer compound and an electrolyte solution, the polymer compound having a structure in which at least one selected from the group consisting of polyvinyl acetal and derivatives thereof is polymerized, the polymer compound being contained in a range from 0.5 wt % to 5 wt %, the electrolytic solution containing a solvent and an electrolyte salt. The solvent contains at least each one of a cyclic compound and a chain compound among carbonate ester and derivatives thereof. The total content of the cyclic compound and the chain compound in the solvent is 80 wt % or more. The ratio between the cyclic compound and the chain compound is in a range from 2:8 to 5:5 as a weight ratio of the cyclic compound to the chain compound.

A battery according to the invention includes a cathode, an anode, and a polymer electrolyte. The polymer electrolyte contains a polymer compound and an electrolyte solution, the polymer compound having a structure in which at least one selected from the group consisting of polyvinyl acetal and derivatives thereof is polymerized, the polymer compound being contained in a range from 0.5 wt % to 5 wt %, the electrolytic solution containing a solvent and an electrolyte salt. The solvent contains at least each one of a cyclic compound and a chain compound among carbonate ester and derivatives thereof. The total content of the cyclic compound and the chain compound in the solvent is 80 wt % or more. A ratio between the cyclic compound and the chain compound is in a range from 2:8 to 5:5 as a weight ratio of the cyclic compound to the chain compound.

According to the polymer electrolyte of the invention, the weight ratio between the cyclic compound and the chain compound in carbonate ester and the derivatives thereof is in a given range. Therefore, high ion conductivity can be obtained. In addition, even when the content of carbonate ester and the derivatives thereof in the solvent is 80 wt % or more, the solubility of polyvinyl acetal and the derivatives thereof can be improved. Thus, the chemical stability of the electrolytic solution can be also improved. Therefore, according to the battery of the invention using the polymer electrolyte, the battery characteristics such as the capacity and the cycle characteristics can be improved.

In particular, when ethylene carbonate is contained as the cyclic compound and the ratio of ethylene carbonate in the solvent is 10 wt % or more and 50 wt % or less, or when methyl ethyl carbonate is contained as the chain compound and the ratio of methyl ethyl carbonate in the solvent is 20 wt % or more and 80 wt % or less, the ion conductivity can be more improved, and higher battery characteristics can be obtained.

### BRIEF DESCRIPTION OF THE DRAWINGS

FIG. 1 is an exploded perspective view showing a structure of a secondary battery according to an embodiment of the invention;

FIG. 2 is a cross section taken along line I-I of a battery element shown in FIG. 1;

FIG. 3 is a characteristics diagram showing a relation between a ratio of a cyclic compound and a chain compound in carbonate ester and, an initial discharge capacity/a capacity retention ratio;

FIG. 4 is a characteristics diagram showing a relation between a content of carbonate ester in a solvent and an initial discharge capacity/a capacity retention ratio; and

FIG. 5 is a characteristics diagram showing a relation between a content of a polymer compound and an initial discharge capacity/a capacity retention ratio.

### BEST MODE FOR CARRYING OUT THE INVENTION

An embodiment of the invention will be hereinafter described in detail with reference to the drawings.

A polymer electrolyte according to an embodiment of the invention contains a polymer compound having a structure in which at least one selected from the group consisting of polyvinyl acetal and the derivatives thereof is polymerized and an electrolytic solution, and is so-called gelatinous.

Polyvinyl acetal is a compound that contains the constitutional unit containing an acetal group shown in Chemical formula 1(A), the constitutional unit containing a hydroxyl group shown in Chemical formula 1(B), and the constitutional unit containing an acetyl group shown in Chemical formula 1(C) as a repeating unit. Specifically, for example, polyvinyl formal in which R shown in Chemical formula 1(A) is hydrogen, or polyvinyl butyral in which R shown in Chemical formula 1(A) is a propyl group can be cited.

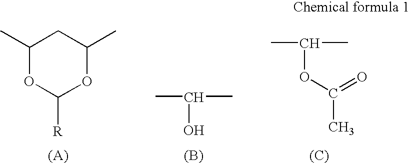

(R represents a hydrogen atom or an alkyl group with the carbon number from 1 to 3.)

The ratio of the acetal group in polyvinyl acetal is preferably in the range from 60 mol % to 80 mol %. In such a range, the solubility to a solvent can be improved, and the stability of the polymer electrolyte can be more improved. Further, the weight average molecular weight of polyvinyl acetal is preferably in the range from 10000 to 500000. When the molecular weight is large, the viscosity becomes increased. Meanwhile, when the molecular weight is small, polymerization reaction is difficult to proceed.

The polymer compound may be obtained by polymerizing only polyvinyl acetal, by polymerizing only one of the derivatives thereof, or by polymerizing two or more thereof. Further, the polymer compound may be obtained by copolymerizing a monomer other than polyvinyl acetal and the derivatives thereof. The content of the polymer compound is preferably in the range from 0.5 wt % to 5 wt %. When the content is less than the foregoing range, the polymerization reaction is difficult to occur, and thus irreversible electrochemical reaction easily occurs due to an unreacted monomer. Meanwhile, when the content is more than the foregoing range, sufficient ion conductivity is not able to be obtained.

The electrolytic solution is obtained by dissolving an electrolyte salt in a solvent. If necessary, the electrolytic solution may contain an additive. The solvent contains at least one of carbonate ester and the derivatives thereof (hereinafter generically referred to as carbonate esters) at a ratio of 80 wt % or more in total. The carbonate esters have high chemical stability. In addition, the solubility of the electrolyte salt therein is high. The carbonate esters contain a mixture of a cyclic compound and a chain compound. The weight ratio between the cyclic compound and the chain compound is in the range from 2:8 to 5:5. Within such a range, high ion conductivity can be obtained, and the solubility of polyvinyl acetal and the derivatives thereof can be improved.

As the cyclic compound, for example, ethylene carbonate, propylene carbonate, butylene carbonate, vinylene carbonate, or a derivative in which at least some of hydrogen in the foregoing compound is substituted with halogen can be cited. As the chain compound, for example, dimethyl carbonate, diethyl carbonate, methyl ethyl carbonate, or a derivative in which at least some of hydrogen in the foregoing compound is substituted with halogen can be cited. One of the foregoing cyclic compounds and one of the foregoing chain compounds may be used singly, respectively, or two or more thereof may be used by mixing, respectively. Specially, as the cyclic compound, ethylene carbonate is preferably contained, and the ratio of ethylene carbonate in the solvent is preferably 10 wt % or more and 50 wt % or less. As the chain compound, methyl ethyl carbonate is preferably contained, and the ratio of methyl ethyl carbonate in the solvent is preferably 20 wt % or more and to 80 wt % or less. Thereby, higher ion conductivity can be obtained.

In the solvent, one or more materials other than carbonate esters may be mixed. As other material, for example, a nonaqueous solvent such as a lactone such as γ-butyrolactone, γ-valerolactone, δ-valerolactone, and c-caprolactone; an ether such as 1,2-dimethoxyethane, 1-ethoxy-2-methoxyethane, 1,2-diethoxyethane, tetrahydrofuran, and 2-methyltetrahydrofuran; nitrile such as acetonitrile; sulfolane; phosphoric acids; phosphoric ester; and pyrrolidones can be cited.

For the electrolyte salt, any electrolyte salt may be used as long as the electrolyte salt is dissolved in the solvent and generates ions. One electrolyte salt may be used singly, or two or more thereof may be used by mixing. For example, in the case of a lithium salt, lithium hexafluorophosphate (LiPF₆), lithium tetrafluoroborate (LiBF₄), lithium hexafluoroarsenate (LiAsF₆), lithium perchlorate (LiClO₄), lithium trifluoromethanesulfonate (LiCF₃SO₃), imide lithium bis(trifluoromethanesulfonyl) (LiN(CF₃SO₂)₂), imide lithium bis(pentafluoroethanesulfonyl) (LiN(C₂F₅SO₂)₂), methyl lithium tris(trifluoromethanesulfonyl) (LiC(CF₃SO₂)₃), methyl lithium tris (pentafluoroethanesulfonyl) (LiC(C₂F₅SO₂)₃), lithium aluminate tetrachloride (LiAlCl₄), lithium hexafluorosilicate (LiSiF₆) or the like can be cited.

Specially, lithium hexafluorophosphate is preferably used, since high ion conductivity and stability can be thereby obtained. Further, an imide salt containing a sulfonyl group such as imide lithium bis(trifluoromethanesulfonyl) and imide lithium bis(pentafluoroethanesulfonyl) is preferably used, since polymerization of polyvinyl acetal and the derivatives thereof can be promoted.

The concentration of the electrolyte salt is preferably in the range from 0.1 mol to 3.0 mol per 1 L of the solvent, and more preferably in the range from 0.5 mol to 2.0 mol per 1 L of the solvent. In such a range, higher ion conductivity can be obtained.

The polymer electrolyte is used for a battery as follows, for example. In this embodiment, descriptions will be given of a battery using lithium as an electrode reactant.

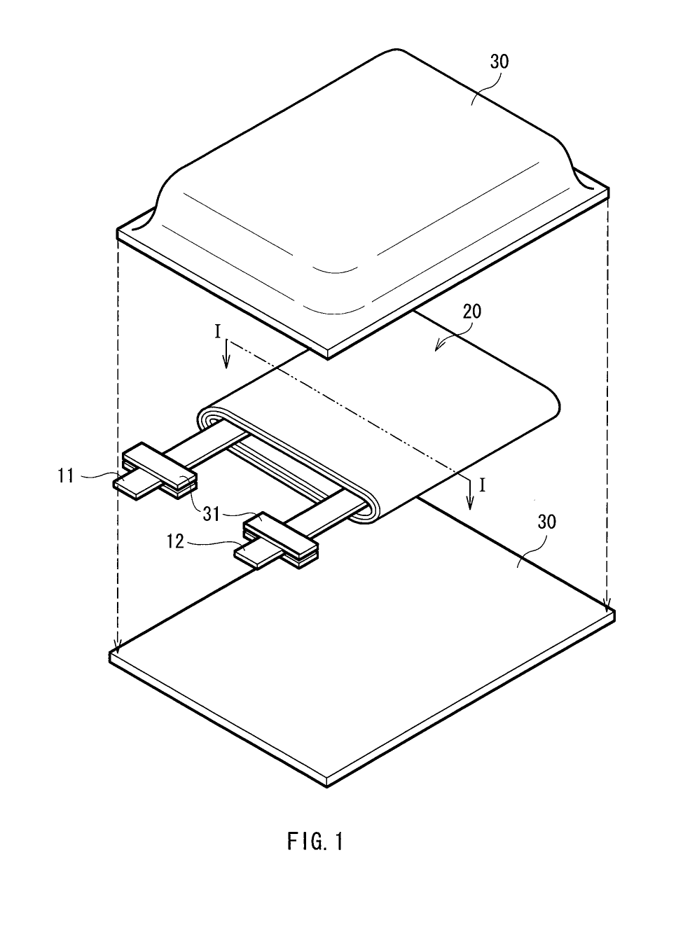

FIG. 1 is an exploded view of a secondary battery using the polymer electrolyte according to this embodiment. In the secondary battery, a battery element 20 on which a cathode terminal 11 and an anode terminal 12 are attached is enclosed inside a film package member 30. The cathode terminal 11 and the anode terminal 12 are respectively directed from inside to outside of the package member 30 in the same direction, for example. The cathode terminal 11 and the anode terminal 12 are respectively made of a metal material such as aluminum (Al), copper (Cu), nickel (Ni), and stainless.

The package member 30 is made of a rectangular laminated film in which, for example, a nylon film, an aluminum foil, and a polyethylene film are bonded together in this order. The package member 30 is arranged, for example, so that the polyethylene film side faces the battery element 20, and the respective outer edges are contacted to each other by fusion bonding or an adhesive. Adhesive films 31 to protect from entering of outside air are inserted between the package member 30 and the cathode terminal 11, the anode terminal 12. The adhesive film 31 is made of a material having contact characteristics to the cathode terminal 11 and the anode terminal 12. For example, when the cathode terminal 11 and the anode terminal 12 are made of the foregoing metal material, the adhesive film 31 is preferably made of a polyolefin resin such as polyethylene, polypropylene, modified polyethylene, and modified polypropylene.

The package member 30 may be made of a laminated film having other structure, a polymer film such as polypropylene, a metal film or the like, instead of the foregoing laminated film.

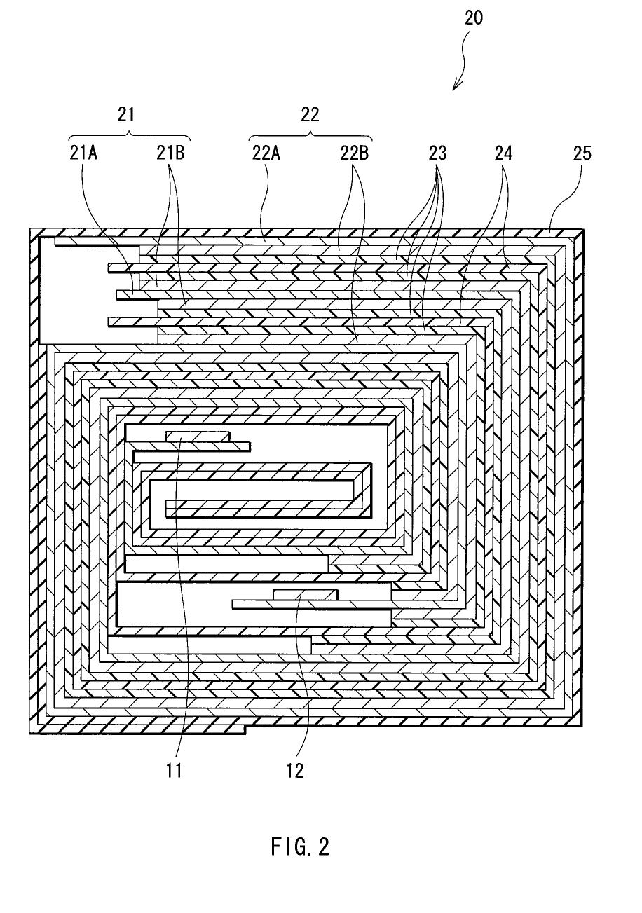

FIG. 2 shows a cross sectional structure taken along line I-I of the battery element 20 shown in FIG. 1. In the battery element 20, a cathode 21 and an anode 22 are located to face each other with a polymer electrolyte 23 according to this embodiment and a separator 24 in between and are spirally wound. The outermost periphery thereof is protected by a protective tape 25.

The cathode 21 has a structure in which, for example, a cathode active material layer 21B is provided on the both faces of a cathode current collector 21A having a pair of opposed faces. In the cathode current collector 21A, there is an exposed portion at one end in the longitudinal direction that is not provided with the cathode active material layer 21B. The cathode terminal 11 is attached to the exposed portion. The cathode current collector 21A is made of, for example, a metal foil such as an aluminum foil, a nickel foil, and a stainless foil.

The cathode active material layer 21B contains, for example, as a cathode active material, one or more cathode materials capable of inserting and extracting lithium. If necessary, the cathode active material layer 21B may contain an electrical conductor and a binder. As a cathode material capable of inserting and extracting lithium, for example, a chalcogenide not containing lithium such as titanium sulfide (TiS₂), molybdenum sulfide (MoS₂), niobium selenide (NbSe₂), and vanadium oxide (V₂O₅); a lithium-containing compound that contains lithium; or a polymer compound such as polyacetylene and polypyrrole can be cited.

Specially, the lithium-containing compound is preferable since some lithium-containing compounds can provide a high voltage and a high energy density. As such a lithium-containing compound, for example, a complex oxide containing lithium and transition metal elements, or a phosphate compound containing lithium and transition metal elements can be cited. In particular, a compound containing at least one of cobalt (Co), nickel, manganese (Mn), and iron (Fe) is preferable, since such a compound can provide a higher voltage. The chemical formula thereof is expressed as, for example, LiₓMIO₂ or Li_{y}MIIPO₄. In the formula, MI and MII represent one or more transition metal elements. Values of x and y vary according to charge and discharge states of the battery, and are generally in the range of 0.05≦x≦1.10 and 0.05≦y≦1.10.

As a specific example of the complex oxide containing lithium and transition metal elements, a lithium-cobalt complex oxide (LiₓCoO₂), a lithium-nickel complex oxide (LiₓNiO₂), a lithium-nickel-cobalt complex oxide (LiₓNi_{1-z}Co_{z}O₂ (z<1)), lithium-manganese complex oxide having spinel structure (LiMn₂O₄) and the like can be cited. As a specific example of the phosphate compound containing lithium and transition metal elements, for example, lithium-iron phosphate compound (LiFePO₄) or a lithium-iron-manganese phosphate compound (LiFe₁₋ᵥMnᵥPO₄ (v<1)) can be cited.

Similarly to the cathode 21, the anode 22 has a structure in which, for example, an anode active material layer 22B is provided on the both faces of an anode current collector 22A having a pair of opposed faces. In the anode current collector 22A, there is an exposed portion at one end in the longitudinal direction that is not provided with the anode active material layer 22B. The anode terminal 12 is attached to the exposed portion. The anode current collector 22A is made of a metal foil such as a copper foil, a nickel foil, and a stainless foil.

The anode active material layer 22B contains, for example, as an anode active material, one or more of anode materials capable of inserting and extracting lithium and metal lithium. If necessary, the anode active material layer 22B may contain an electrical conductor and a binder. As an anode material capable of inserting and extracting lithium, for example, a carbon material, a metal oxide, or a polymer compound can be cited. As a carbon material, a non-graphitizable carbon material, a graphite material and the like can be cited. More specifically, pyrolytic carbons, coke, graphites, glassy carbons, an organic polymer compound fired body, carbon fiber, activated carbon and the like can be cited. Of the foregoing, the coke includes pitch coke, needle coke, petroleum coke and the like. The organic polymer compound fired body is obtained by firing and carbonizing a polymer material such as a phenol resin and a furan resin at an appropriate temperature. As a metal oxide, iron oxide, ruthenium oxide, molybdenum oxide or the like can be cited. As a polymer compound, polyacetylene, polypyrrole or the like can be cited.

As an anode material capable of inserting and extracting lithium, a material that contains at least one of metal elements and metalloid elements capable of forming an alloy with lithium as an element can be also cited. Such an anode material may be a simple substance, an alloy, or a compound of a metal element or a metalloid element, or may have one or more phases thereof at least in part. In the invention, alloys include an alloy containing one or more metal elements and one or more metalloid elements, in addition to an alloy including two or more metal elements. Further, an alloy may contain nonmetallic elements. The texture thereof includes a solid solution, a eutectic crystal (eutectic mixture), an intermetallic compound, and a texture in which two or more thereof coexist.

As such a metal element or such a metalloid element, for example, tin (Sn), lead (Pb), aluminum, indium (In), silicon (Si), zinc (Zn), antimony (Sb), bismuth (Bi), gallium (Ga), germanium (Ge), arsenic (As), silver (Ag), hafnium (Hf), zirconium (Zr), and yttrium (Y) can be cited. Specially, a metal element or a metalloid element of Group 14 in the long period periodic table is preferable. Silicon and tin are particularly preferable. Silicon and tin have a high ability to insert and extract lithium, and can obtain a high energy density.

As an alloy of tin, for example, an alloy containing at least one selected from the group consisting of silicon, nickel, copper, iron, cobalt, manganese, zinc, indium, silver, titanium (Ti), germanium, bismuth, antimony, and chromium (Cr) as a second element other than tin can be cited. As an alloy of silicon, for example, an alloy containing at least one selected from the group consisting of tin, nickel, copper, iron, cobalt, manganese, zinc, indium, silver, titanium, germanium, bismuth, antimony, and chromium as a second element other than silicon can be cited.

As a compound of tin or a compound of silicon, for example, a compound containing oxygen (O) or carbon (C) can be cited. In addition to tin or silicon, the compound may contain the foregoing second element.

The separator 24 is made of an insulative thin film having the high ion permeability and a given mechanical strength such as a porous film made of a polyolefin synthetic resin such as polypropylene and polyethylene, and a porous film made of an inorganic material such as a ceramics nonwoven. The separator 24 may have a structure in which two or more porous films as the foregoing porous films are layered. Specially, the separator containing the polyolefin porous film is preferable, since such a separator favorably separates the cathode 21 from the anode 22, and can further decrease internal short circuit and lowering of the open circuit voltage.

The secondary battery can be manufactured, for example, as follows.

First, the cathode 21 is formed. For example, when a particulate cathode active material is used, a cathode mixture is prepared by mixing the cathode active material, and if necessary an electrical conductor and a binder. The cathode mixture is dispersed in a dispersion medium such as N-methyl-2-pyrrolidone to form cathode mixture slurry. After that, the cathode current collector 21A is coated with the cathode mixture slurry, which is then dried and compression-molded to form the cathode active material layer 21B.

Further, the anode 22 is formed. For example, when a particulate anode active material is used, an anode mixture is prepared by mixing the anode active material, and if necessary an electrical conductor and a binder. The anode mixture is dispersed in a dispersion medium such as N-methyl-2-pyrrolidone to form anode mixture slurry. After that, the anode current collector 22A is coated with the anode mixture slurry, which is then dried and compression-molded to form the anode active material layer 22B.

Next, the cathode terminal 11 is attached to the cathode 21, and the anode terminal 12 is attached to the anode 22. After that, the separator 24, the cathode 21, the separator 24, and the anode 22 are sequentially layered and spirally wound. The protective tape 25 is adhered to the outermost periphery thereof to form a spirally wound electrode body. Subsequently, the spirally wound electrode body is sandwiched between the package members 30, and peripheral edges of the package members 30 except for one side are thermally fusion-bonded to obtain a pouched state.

After that, an electrolyte composition of matter that contains at least one monomer of the foregoing polyvinyl acetal and the derivatives thereof, an electrolytic solution, and a catalyst if necessary is prepared. The electrolyte composition of matter is injected into the spirally wound electrode body from the opening of the package member 30, and is enclosed by thermally fusion-bonding the opening of the package member 30. Thereby, the monomer is polymerized inside the package member 30 and the polymer electrolyte 23 is formed, and the secondary battery shown in FIG. 1 and FIG. 2 is completed.

Alternatively, the secondary battery may be manufactured as follows. For example, instead of injecting the electrolyte composition of matter after forming the spirally wound electrode body, it is possible that the cathode 21 and the anode 22, or the separator 24 is coated with the electrolyte composition of matter, the lamination is spirally wound, and then the spirally wound body is enclosed inside the package member 30. Otherwise, it is possible that the cathode 21 and the anode 22, or the separator 24 is coated with at least one monomer of polyvinyl acetal and the derivatives thereof, the lamination is spirally wound, the spirally wound body is contained inside the package member 30, and then the electrolytic solution is therein injected. However, the monomer is preferably polymerized inside the package member 30, since joint characteristics between the polymer electrolyte 23 and the separator 24 is improved, and the internal resistance can be lowered. Further, the polymer electrolyte 23 is preferably formed by injecting the electrolyte composition of matter into the package member 30, since manufacturing is easily made with fewer steps.

In the secondary battery, when charged, for example, lithium ions are extracted from the cathode active material layer 21B and inserted in the anode active material layer 22B through the polymer electrolyte 23. When discharged, for example, lithium ions are extracted from the anode active material layer 22B and inserted in the cathode active material layer 21B through the polymer electrolyte 23. In this embodiment, carbonate esters are used as a solvent, and the ratio between the cyclic compound and the chain compound is in a given range. Therefore, high ion conductivity can be obtained. In addition, even when the ratio of the carbon esters in the solvent is increased, uniform gel is formed. In the result, the chemical stability of the electrolytic solution is improved, and lowering of the characteristics is prevented.

As above, according to this embodiment, the weight ratio between the cyclic compound and the chain compound in the carbonate esters is in the range from 2:8 to 5:5. Therefore, the high ion conductivity can be obtained, and the solubility of the polymer compound can be improved even when the ratio of the carbonate esters in the solvent is increased. In the result, the chemical stability of the electrolytic solution is improved, and the battery characteristics such as the capacity and the cycle characteristics can be improved.

In particular, when ethylene carbonate is contained as the cyclic compound, and the ratio of ethylene carbonate in the solvent is 10 wt % or more and 50 wt % or less, or when methyl ethyl carbonate is contained as the chain compound, and the ratio of methyl ethyl carbonate in the solvent is 20 wt % or more and 80 wt % or less, the ion conductivity can be more improved, and higher battery characteristics can be obtained.

### EXAMPLES

Further, specific examples of the invention will be hereinafter described in detail.

### Examples 1-1 to 1-4

The laminated film type secondary batteries as shown in FIGS. 1 and 2 were fabricated.

First, 0.5 mol of lithium carbonate (Li₂CO₃) and 1 mol of cobalt carbonate (CaCO₃) were mixed. The mixture was fired for 5 hours at 900 deg C. in the air to synthesize lithium-cobalt complex oxide (LiCoO₂) as a cathode active material. Next, 85 parts by weight of the lithium-cobalt complex oxide, 5 parts by weight of graphite as an electrical conductor, and 10 parts by weight of polyvinylidene fluoride as a binder were mixed to prepare a cathode mixture. The cathode mixture was dispersed in N-methyl-2-pyrrolidone as a dispersion medium to form cathode mixture slurry. Subsequently, the both faces of the cathode current collector 21A made of an aluminum foil being 20 μm thick were uniformly coated with the cathode mixture slurry, which was then dried and compression-molded by a roll pressing machine to form the cathode active material layer 21B and form the cathode 21. After that, the cathode terminal 11 was attached to the cathode 21.

Further, for the anode active material, pulverized graphite powder was used. 90 parts by weight of the graphite powder and 10 parts by weight of polyvinylidene fluoride as a binder were mixed to prepare an anode mixture. After that, the anode mixture was dispersed in N-methyl-2-pyrrolidone as a dispersion medium to form anode mixture slurry. Subsequently, the both faces of the anode current collector 22A made of a copper foil being 15 μm thick were uniformly coated with the anode mixture slurry, which was then dried and compression-molded to form the anode active material layer 22B and form the anode 22. After that, the anode terminal 12 was attached to the anode 22.

After that, the formed cathode 21 and the formed anode 22 were contacted with the separator 24 made of a microporous polyethylene film being 25 μm thick in between, the lamination was wound in the longitudinal direction, the protective tape 25 was adhered to the outermost periphery to form a spirally wound electrode body. Next, the spirally wound electrode body was sandwiched between the package members 30, and peripheral edges of the package members 30 except for one side were bonded together to obtain a pouched state. For the package member 30, a dampproof aluminum laminated film in which a nylon film being 25 μm thick, an aluminum foil being 40 μm thick, and a polypropylene film being 30 μm thick were layered sequentially from the outermost layer was used.

Subsequently, an electrolyte composition of matter in which polyvinyl formal and an electrolytic solution were mixed was injected from the opening of the package member 30, and the opening was thermally fusion-bonded under depressurization to hermetically seal the electrolyte composition of matter. As the electrolytic solution, a solution obtained by dissolving lithium hexafluorophosphate at a concentration of 1.0 mol/L in a solvent of 100 wt % of carbonate ester in which ethylene carbonate as a cyclic compound and methyl ethyl carbonate as a chain compound were mixed was used. The weight ratio between ethylene carbonate and methyl ethyl carbonate was changed in Examples 1-1 to 1-4 as follows. In Example 1-1, ethylene carbonate: methyl ethyl carbonate was 2:8. In Example 1-2, ethylene carbonate: methyl ethyl carbonate was 3:7. In Example 1-3, ethylene carbonate: methyl ethyl carbonate was 4:6. In Example 1-4, ethylene carbonate: methyl ethyl carbonate was 5:5. The weight average molecular weight of polyvinyl formal was about 50000, and the mol ratio among a formal group, a hydroxyl group, and an acetyl group was almost 75.5:12.3:12.2. The ratio between polyvinyl formal and the electrolytic solution was 2:98 at the weight ratio. After that, polyvinyl formal was polymerized by heating, the resultant was sandwiched by glass plates and left for 24 hours. Thereby, the polymer electrolyte 23 was formed, and the secondary battery shown in FIGS. 1 and 2 was fabricated.

As Comparative examples 1-1 and 1-2 relative to Examples 1-1 to 1-4, secondary batteries were fabricated in the same manner as in Examples 1-1 to 1-4, except that the weight ratio between ethylene carbonate and methyl ethyl carbonate was 1.5:8.5 or 5.5:4.5.

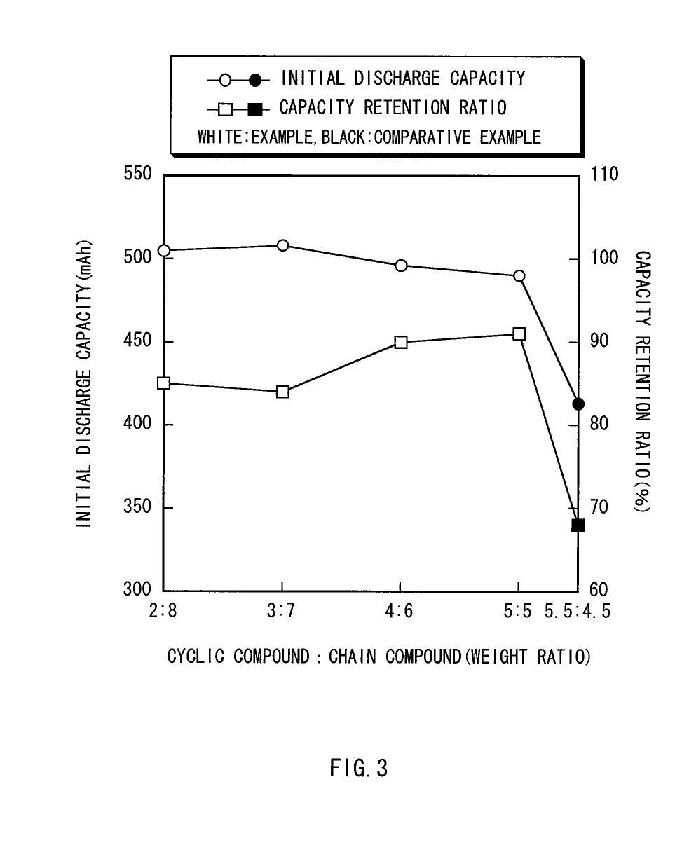

For the fabricated secondary batteries of Examples 1-1 to 1-4 and Comparative examples 1-1 and 1-2, 100 mA constant current and constant voltage charge was performed at 23 deg C. for 15 hours to the upper limit voltage of 4.2 V. Next, 100 mA constant current discharge was performed to the final voltage of 2.5 V, and the discharge capacity was then obtained as the initial discharge capacity. Further, for each secondary battery with the initial discharge capacity obtained, 300 cycles in which 500 mA constant current and constant voltage discharge was performed at 23 deg C. for 2 hours to the upper limit voltage of 4.2 V, and then 500 mA constant current discharge was performed to the final voltage of 2.5 V were performed. Then, the capacity retention ratio of the discharge capacity at the 300th cycle where the discharge capacity at the first cycle in 500 mA constant current discharge was 100% was obtained. The results are shown in Table 1 and FIG. 3. In Comparative example 1-1, polyvinyl formal was not sufficiently dissolved in the solvent, and thus the characteristics were not able to be measured.

TABLE 1

| | | Carbonate ester | | | |
|---|---|---|---|---|---|
| | Content of | Content | | Initial | Capacity |
| | polymer | in | | discharge | retention |
| | compound | solvent | Cyclic:chain | capacity | ratio |
| | (wt %) | (wt %) | (wt ratio) | (mAh) | (%) |
| Example 1-1 | 2 | 100 | 2:8 | 505 | 85 |
| Example 1-2 | | | 3:7 | 508 | 84 |
| Example 1-3 | | | 4:6 | 496 | 90 |
| Example 1-4 | | | 5:5 | 490 | 91 |
| Comparative | 2 | 100 | 1.5:8.5 | Incapable | Incapable |
| example 1-1 | | | | measure- | measure- |
| | | | | ment | ment |
| Comparative | | | 5.5:4.5 | 413 | 68 |
| example 1-2 | | | | | |

As shown in Table 1 and FIG. 3, in Comparative example 1-1 in which the weight ratio between the cyclic compound and the chain compound was 1.5:8.5, polyvinyl acetal was not able to be sufficiently dissolved. Further, there was a tendency that as the ratio of the cyclic compound was increased and the ratio of the chain compound was decreased, the initial discharge capacity and the capacity retention ratio were improved, showed the maximum value, and then decreased. Further, in Comparative example 1-2 in which the weight ratio between the cyclic compound and the chain compound was 5.5:4.5, the initial discharge capacity and the capacity retention ratio were drastically decreased compared to in Examples 1-1 to 1-4.

That is, it was found that when the weight ratio between the cyclic compound and the chain compound in carbon esters was in the range from 2:8 to 5:5, the solubility of polyvinyl acetal could be improved, and the discharge capacity and the cycle characteristics could be improved.

### Example 2-1

A secondary battery was fabricated in the same manner as in Example 1-2, except that a mixed solvent of 80 wt % of carbonate ester in which ethylene carbonate and methyl ethyl carbonate were mixed at a weight ratio of ethylene carbonate:methyl ethyl carbonate=3:7 and 20 wt % of tetrahydrofuran was used. Further, as Comparative example 2-1 relative to this example, a secondary battery was fabricated in the same manner as in Example 2-1, except that the content of carbonate ester was 75 wt % and the content of tetrahydrofuran was 25 wt %.

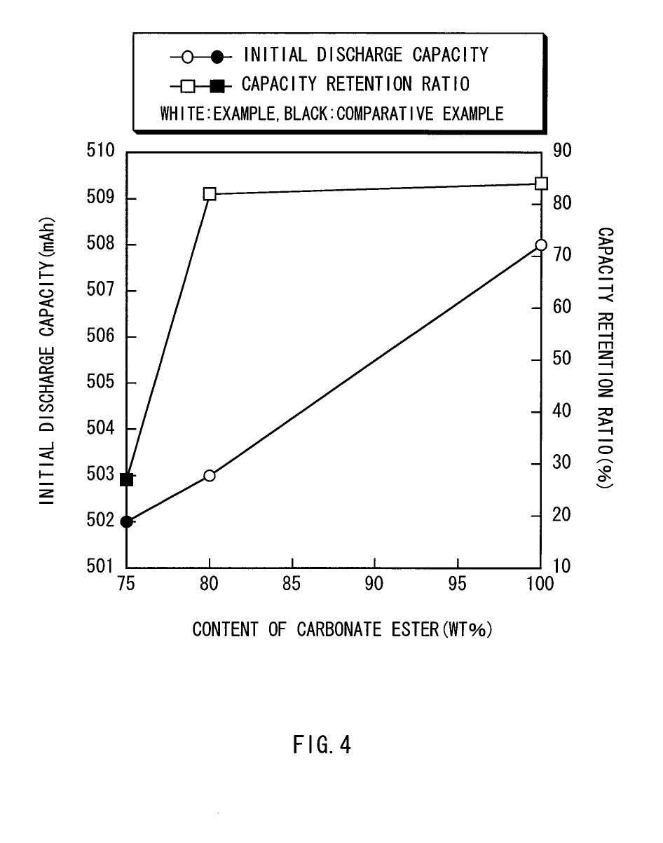

For the fabricated secondary batteries of Example 2-1 and Comparative example 2-1, charge and discharge were performed in the same manner as in Example 1-2, and the initial discharge capacity and the capacity retention ratio were obtained. The results are shown in Table 2 and FIG. 4 together with the results of Example 1-2.

TABLE 2

| | | Carbonate ester | | | |
|---|---|---|---|---|---|
| | Content of | Content | | Initial | Capacity |
| | polymer | in | | discharge | retention |
| | compound | solvent | Cyclic:chain | capacity | ratio |
| | (wt %) | (wt %) | (wt ratio) | (mAh) | (%) |
| Example 1-2 | 2 | 100 | 3:7 | 508 | 84 |
| Example 2-1 | | 80 | | 503 | 82 |
| Comparative | 2 | 75 | 3:7 | 502 | 27 |
| example 2-1 | | | | | |

As shown in Table 2 and FIG. 4, there was a tendency that as the content of carbonate ester in the solvent was decreased, the initial discharge capacity and the capacity retention ratio were decreased. In Comparative example 2-1 in which the content of carbonate ester was 75 wt %, the capacity retention ratio was significantly decreased. That is, it was found that when the content of carbonate esters in the solvent was 80 wt % or more, the chemical stability could be improved, and the discharge capacity and the cycle characteristics could be improved.

### Examples 3-1 and 3-2

Secondary batteries were fabricated in the same manner as in Example 1-2, except that the weight ratio between polyvinyl formal and the electrolytic solution was 0.5:99.5 or 5:95. Further, as Comparative examples 3-1 and 3-2 relative to these examples, secondary batteries were fabricated in the same manner as in Example 1-2, except that the weight ratio between polyvinyl formal and the electrolytic solution was 0.4:99.6 or 5.5:94.5.

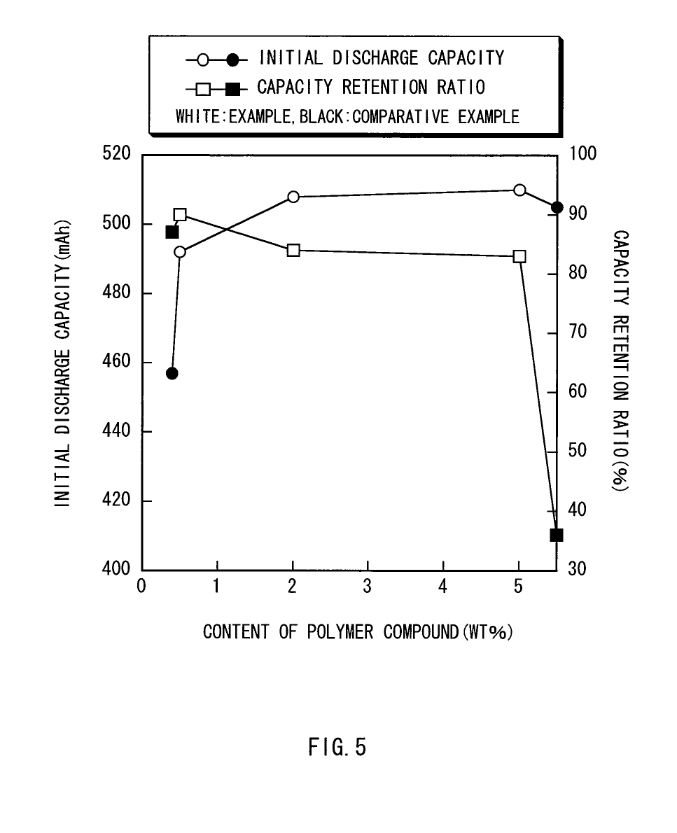

For the fabricated secondary batteries of Examples 3-1 and 3-2 and Comparative examples 3-1 and 3-2, charge and discharge were performed in the same manner as in Example 1-2, and the initial discharge capacity and the capacity retention ratio were obtained. The results are shown in Table 3 and FIG. 5 together with the results of Example 1-2.

TABLE 3

| | | Carbonate ester | | | |
|---|---|---|---|---|---|
| | Content of | Content | | Initial | Capacity |
| | polymer | in | | discharge | retention |
| | compound | solvent | Cyclic:chain | capacity | ratio |
| | (wt %) | (wt %) | (wt ratio) | (mAh) | (%) |
| Example 3-1 | 1.5 | 100 | 3:7 | 492 | 90 |
| Example 1-2 | 2 | | | 508 | 84 |
| Example 3-2 | 5 | | | 510 | 83 |
| Comparative | 0.4 | 100 | 3:7 | 457 | 87 |
| example 3-1 | | | | | |
| Comparative | 5.5 | | | 505 | 36 |
| example 3-2 | | | | | |

As shown in Table 3 and FIG. 5, there was a tendency that as the content of the polymer compound was increased, the initial discharge capacity and the capacity retention ratio were improved, showed the maximum value, and then decreased. In Comparative example 3-1 in which the content of the polymer compound was small, the initial discharge capacity was significantly decreased. In Comparative example 3-2 in which the content of the polymer compound was high, the capacity retention ratio was significantly decreased. That is, it was found that the content of the polymer compound was preferably in the range from 0.5 wt % to 5 wt %, since the discharge capacity and the cycle characteristics could be thereby improved.

### Examples 4-1 to 4-19

Secondary batteries were fabricated in the same manner as in Examples 1-1 to 1-4, except that the composition of carbonate ester in the solvent was changed as shown in Tables 4 to 7. Specifically, as a cyclic compound, ethylene carbonate or a mixture of ethylene carbonate and propylene carbonate was used. As a chain compound, ethyl methyl compound or a mixture of ethyl methyl carbonate and diethyl carbonate was used.

For the fabricated secondary batteries of Examples 4-1 to 4-19, charge and discharge were performed in the same manner as in Examples 1-1 to 1-4, and the initial discharge capacity and the capacity retention ratio were obtained. The results are shown in Tables 4 to 7 together with the results of Examples 1-1 to 1-4.

TABLE 4

| | Carbonate ester (weight ratio) | | | | | |
|---|---|---|---|---|---|---|
| | cyclic:chain = 2:8 | | | | Initial | Capacity |
| | Cyclic | | Chain | | discharge | retention |
| | compound | | compound | | capacity | ratio |
| | EC | PC | MEC | DEC | (mAh) | (%) |
| Example 1-1 | 2 | 0 | 8 | 0 | 505 | 85 |
| Example 4-1 | 1 | 1 | 8 | 0 | 497 | 85 |
| Example 4-2 | 2 | 0 | 4 | 4 | 497 | 89 |
| Example 4-3 | 1 | 1 | 4 | 4 | 497 | 88 |

EC: ethylene carbonate
PC: propylene carbonate
MEC: methyl ethyl carbonate
DEC: diethyl carbonate

TABLE 5

| | Carbonate ester | | | | | |
|---|---|---|---|---|---|---|
| | (weight ratio) | | | | | |
| | cyclic:chain = 3:7 | | | | Initial | Capacity |
| | Cyclic | | Chain | | discharge | retention |
| | compound | | compound | | capacity | ratio |
| | EC | PC | MEC | DEC | (mAh) | (%) |
| Example 1-2 | 3 | 0 | 7 | 0 | 508 | 84 |
| Example 4-4 | 2 | 1 | 7 | 0 | 497 | 88 |
| Example 4-5 | 1 | 2 | 7 | 0 | 491 | 90 |
| Example 4-6 | 0.9 | 2.1 | 7 | 0 | 461 | 90 |
| Example 4-7 | 3 | 0 | 6 | 1 | 497 | 90 |
| Example 4-8 | 2 | 1 | 6 | 1 | 497 | 89 |
| Example 4-9 | 2 | 1 | 5 | 2 | 495 | 91 |
| Example 4-10 | 2 | 1 | 4 | 3 | 494 | 92 |
| Example 4-11 | 2 | 1 | 3 | 4 | 488 | 93 |
| Example 4-12 | 2 | 1 | 2 | 5 | 484 | 93 |
| Example 4-13 | 2 | 1 | 1.8 | 5.2 | 435 | 93 |

EC: ethylene carbonate
PC: propylene carbonate
MEC: methyl ethyl carbonate
DEC: diethyl carbonate

TABLE 6

| | Carbonate ester | | | | | |
|---|---|---|---|---|---|---|
| | (weight ratio) | | | | | |
| | cyclic:chain = 4:6 | | | | Initial | Capacity |
| | Cyclic | | Chain | | discharge | retention |
| | compound | | compound | | capacity | ratio |
| | EC | PC | MEC | DEC | (mAh) | (%) |
| Example 1-3 | 4 | 0 | 6 | 0 | 496 | 90 |
| Example 4-14 | 2 | 2 | 6 | 0 | 485 | 90 |
| Example 4-15 | 4 | 0 | 3 | 3 | 481 | 93 |
| Example 4-16 | 2 | 2 | 3 | 3 | 485 | 92 |

EC: ethylene carbonate
PC: propylene carbonate
MEC: methyl ethyl carbonate
DEC: diethyl carbonate

TABLE 7

| | Carbonate ester | | | | | |
|---|---|---|---|---|---|---|
| | (weight ratio) | | | | | |
| | cyclic:chain = 4:6 | | | | Initial | Capacity |
| | Cyclic | | Chain | | discharge | retention |
| | compound | | compound | | capacity | ratio |
| | EC | PC | MEC | DEC | (mAh) | (%) |
| Example 1-4 | 5 | 0 | 5 | 0 | 490 | 91 |
| Example 4-17 | 2 | 3 | 5 | 0 | 480 | 90 |
| Example 4-18 | 5 | 0 | 2 | 3 | 481 | 90 |
| Example 4-19 | 2 | 3 | 2 | 3 | 479 | 91 |

EC: ethylene carbonate
PC: propylene carbonate
MEC: methyl ethyl carbonate
DEC: diethyl carbonate

As shown in Tables 4 to 7, there was a tendency that when the content of ethylene carbonate in the cyclic compound was decreased, the capacity retention ratio was maintained or improved, but the initial discharge capacity was decreased. In Example 4-6 in which the content of ethylene carbonate in the solvent was 9 wt %, the initial discharge capacity was largely decreased. Further, similarly, there was a tendency that when the content of methyl ethyl carbonate in the cyclic compound was decreased, the capacity retention ratio was maintained or improved, but the initial discharge capacity was decreased. In Example 4-13 in which the content of methyl ethyl carbonate in the solvent was 18 wt %, the initial discharge capacity was largely decreased. That is, it was found that the content of ethylene carbonate in the solvent was preferably in the range from 10 wt % to 50 wt %, or the content of methyl ethyl carbonate in the solvent was preferably in the range from 20 wt % to 80 wt %, since thereby the discharge capacity and the cycle characteristics could be improved.

The invention has been described with reference to the embodiment and the examples. However, the invention is not limited to the embodiment and the examples, and various modifications may be made. For example, in the foregoing embodiment and the foregoing examples, descriptions have been given of the case provided with the battery element 20 in which the cathode 21 and the anode 22 are layered and spirally wound. However, the invention can be also applied to a case provided with a plate battery element in which a pair of a cathode and an anode is layered, or a case provided with a lamination type battery element in which a plurality of cathodes and a plurality of anodes are layered. Further, in the foregoing embodiment and the foregoing examples, descriptions have been given of the case in which the film package member 30 is used. However, the invention can be similarly applied to a battery having other shape such as a so-called cylinder type battery, a square type battery, a coin type battery, and a button type battery that uses a can for the package member. Furthermore, the invention can be applied to primary batteries in addition to the secondary batteries.

In addition, in the foregoing embodiment and the foregoing examples, descriptions have been given of the battery using lithium as an electrode reactant. However, the invention can be also applied to the case using other alkali metal such as sodium (Na) and potassium (K); an alkali earth metal such as magnesium and calcium (Ca); or other light metal such as aluminum.

1. A polymer electrolyte containing a polymer compound and an electrolyte solution, the polymer compound having a structure in which at least one selected from the group consisting of polyvinyl acetal and derivatives thereof is polymerized, the polymer compound being contained in a range from 0.5 wt % to 5 wt %, the electrolytic solution containing a solvent and an electrolyte salt, wherein:
the solvent contains at least each one of a cyclic compound and a chain compound among carbonate ester and derivatives thereof,
a total content of the cyclic compound and the chain compound in the solvent is 80 wt % or more, and
a ratio between the cyclic compound and the chain compound is in a range from 2:8 to 5:5 as a weight ratio of the cyclic compound to the chain compound.

2. The polymer electrolyte according to claim 1, wherein at least one of the cyclic compound is ethylene carbonate, and a ratio of ethylene carbonate in the solvent is 10 wt % or more and 50 wt % or less.

3. The polymer electrolyte according to claim 1, wherein at least one of the chain compound is methyl ethyl carbonate, and a ratio of methyl ethyl carbonate in the solvent is 20 wt % or more and 80 wt % or less.

4. The polymer electrolyte according to claim 1, wherein the polymer compound has a structure in which at least one selected from the group consisting of polyvinyl formal and derivatives thereof is polymerized.

5. A battery comprising a cathode, an anode, and a polymer electrolyte wherein:
the polymer electrolyte contains a polymer compound and an electrolyte solution, the polymer compound having a structure in which at least one selected from the group consisting of polyvinyl acetal and derivatives thereof is polymerized, the polymer compound being contained in a range from 0.5 wt % to 5 wt %, the electrolytic solution containing a solvent and an electrolyte salt,
the solvent contains at least each one of a cyclic compound and a chain compound among carbonate ester and derivatives thereof,
a total content of the cyclic compound and the chain compound in the solvent is 80 wt % or more, and
a ratio between the cyclic compound and the chain compound is in a range from 2:8 to 5:5 as a weight ratio of the cyclic compound to the chain compound.

6. The battery according to claim 5, wherein at least one of the cyclic compound is ethylene carbonate, and a ratio of ethylene carbonate in the solvent is 10 wt % or more and 50 wt % or less.

7. The battery according to claim 5, wherein at least one of the chain compound is methyl ethyl carbonate, and a ratio of methyl ethyl carbonate in the solvent is 20 wt % or more and 80 wt % or less.

8. The battery according to claim 5, wherein the polymer compound has a structure in which at least one selected from the group consisting of polyvinyl formal and derivatives thereof is polymerized.
